(19) United States
(12) Patent Application Publication
(10) Pub. No.: US 2007/0074160 A1
(43) Pub. Date: Mar. 29, 2007

(54) Apparatus and method for manipulating report segments

(75) Inventor: Damian Luke Biollo, Vancouver (CA)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/391,070

(22) Filed: Mar. 27, 2006

Related U.S. Application Data
(60) Provisional application No. 60/720,184, filed on Sep. 23, 2005.

(51) Int. Cl. G06F 9/44

(52) U.S. Cl. 717/113; 717/105

(57) ABSTRACT

A computer readable medium includes executable instructions to display a report as a set of report segments; facilitate the expansion and collapse of individual report segments; and coordinate drag and drop operations between individual report segments.

### CROSS REFERENCE TO RELATED APPLICATIONS

This application claims the benefit of U.S. Provisional Application Ser. No. 60/720,184, entitled “Apparatus and Method for Manipulating Report Segments,” filed Sep. 23, 2005, the contents of which are hereby incorporated by reference in their entirety.

### BRIEF DESCRIPTION OF THE INVENTION

This invention relates generally to digital data reports. More particularly, this invention relates to the manipulation of report segments in a graphical user interface.

### BACKGROUND OF THE INVENTION

There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

Reports can be very large. As a result, problems arise when trying to view reports. In particular, only a small portion of the report may be viewed. In addition, it is difficult for a user to develop a sense for the organization of the report if it is necessary to scroll through various parts of the report. These problems can be appreciated with reference to FIG. 1.

FIG. 1 illustrates a portion of a report 100 as displayed in a prior art graphical user interface. Observe that the report 100 cannot be fully viewed given the size of the screen. In particular, the figure illustrates a report header section 102, which includes graphical information. A page header 104 entitled “Quarterly report” is also illustrated. The report 100 also includes a first group 106, a second group 108, and a third group 110. For each group, only a small set of information is displayed. The scroll bar 112 indicates that there is additional report content that is not visible.

In view of the foregoing, it would be desirable to provide improved techniques for manipulating reports. In particular, it would be desirable to provide techniques for manipulating segments of reports.

### SUMMARY OF THE INVENTION

The invention includes a computer readable medium with executable instructions to display a report as a set of report segments. The executable instructions facilitate the expansion and collapse of individual report segments and coordinate drag and drop operations between individual report segments.

### BRIEF DESCRIPTION OF THE FIGURES

The invention is more fully appreciated in connection with the following detailed description taken in conjunction with the accompanying drawings, in which:

FIG. 1 illustrates a report as displayed in a prior art graphical user interface.

FIG. 2 illustrates a collapsed report in accordance with an embodiment of the invention.

FIG. 3 illustrates the expansion of selected report segments in accordance with an embodiment of the invention.

FIG. 4 illustrates dragging and dropping operations performed in accordance with an embodiment of the invention.

FIG. 5 illustrates processing operations associated with an embodiment of the invention.

FIG. 6 illustrates processing operations associated with an alternate embodiment of the invention.

FIG. 7 illustrates a computer configured in accordance with an embodiment of the invention.

Like reference numerals refer to corresponding parts throughout the several views of the drawings.

### DETAILED DESCRIPTION OF THE INVENTION

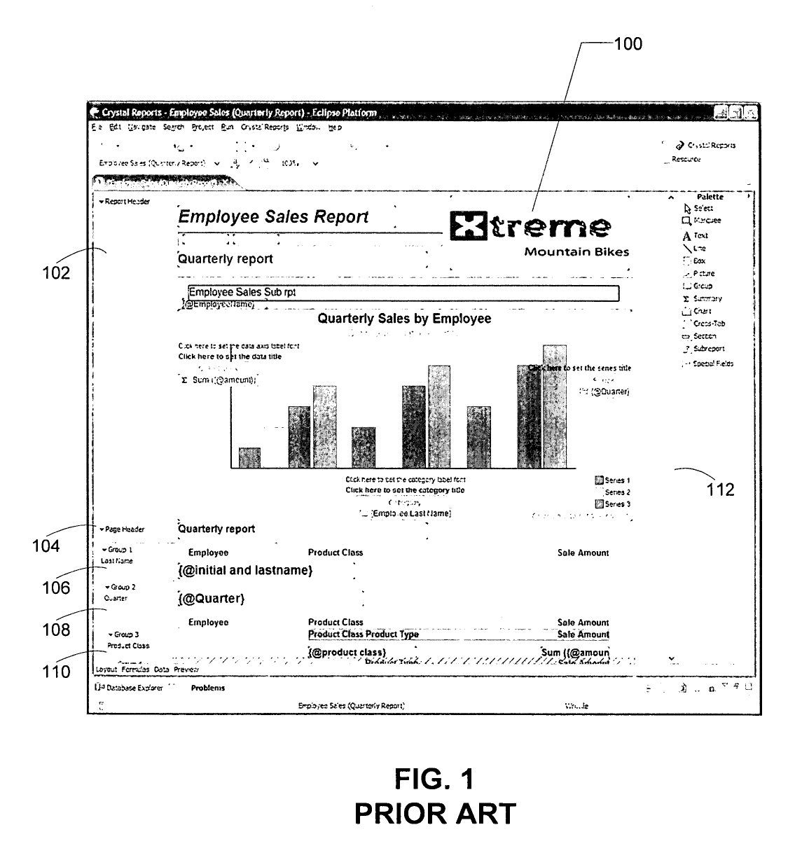

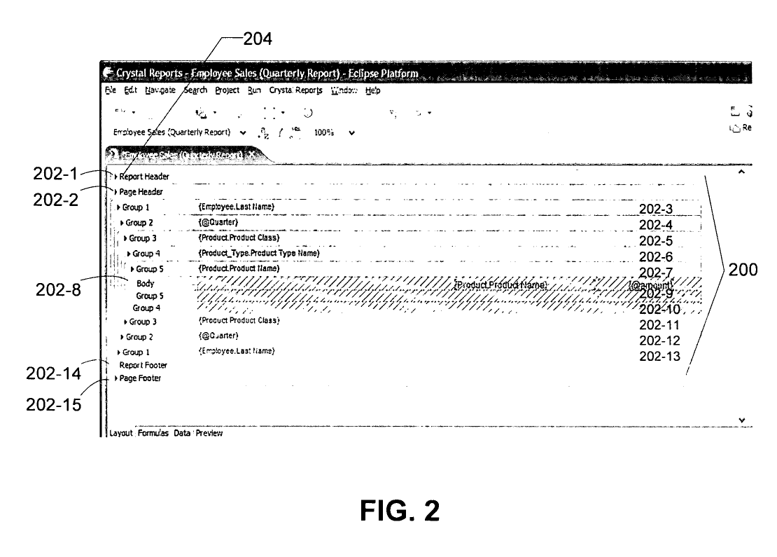

FIG. 2 illustrates a report 200 configured in accordance with an embodiment of the invention. The report 200 includes individual report segments 202_1 through 202_15. Each report segment 202 has a sizing activation region (indicated by an arrowhead) 204, which allows for the expansion or collapse of a report segment. Thus, FIG. 2 illustrates the report of FIG. 1 after all report segments are fully collapsed.

In one embodiment of the invention, there are two types of report segments: area segments and group segments. Area segments are part of the fixed structure of a report. In this example, the area segments include a report header 202_1, a page header 202_2, a report footer 202_14, and a page footer 202_15. Since the area segments are part of the fixed structure of a report, they cannot be moved. Group segments are subsets of area segments. Group segments can be moved in accordance with an embodiment of the invention.

FIG. 2 illustrates group segments 202_3, 202_4, 202_5, 202_6, 202_10, 202_11, 202_12 and 202_13, which form a portion of a report page area between the page header 202_2 and the report footer 202_14. Group segments 202_7, 202_8 and 202_9 illustrate a group segment that contains a body 202_8 where 202_7 is the group header and 202_9 is the group footer.

Group segments represent data grouping sections, such as Product Name, Country, State, City, Salesperson, etc. Group segments can be moved within the report structure by selecting, dragging and dropping using tabs (e.g., arrowheads) 204. In one embodiment, groups have both headers and footers. For example, as previously mentioned, group segment body 202_8 has a header 202_7 and a footer 202_9. Moving a group moves content from both the header and footer. In one embodiment, the numbering of the groups remains sequential and only the content is moved.

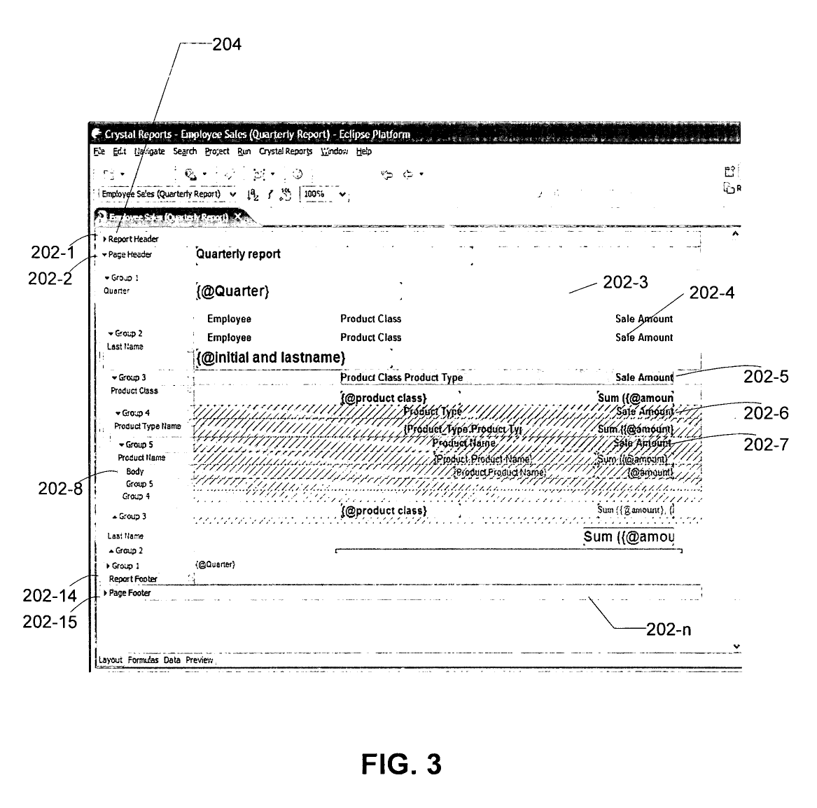

FIG. 3 illustrates the first several report segments 202 expanded. In particular, the report segments 202_3 through 202_6 are expanded. The expansion was accomplished by selecting the sizing activation region 204 of each segment. This figure illustrates that the invention allows an individual designing a report to display desired report segments, while leaving other report content collapsed, thereby saving screen real estate.

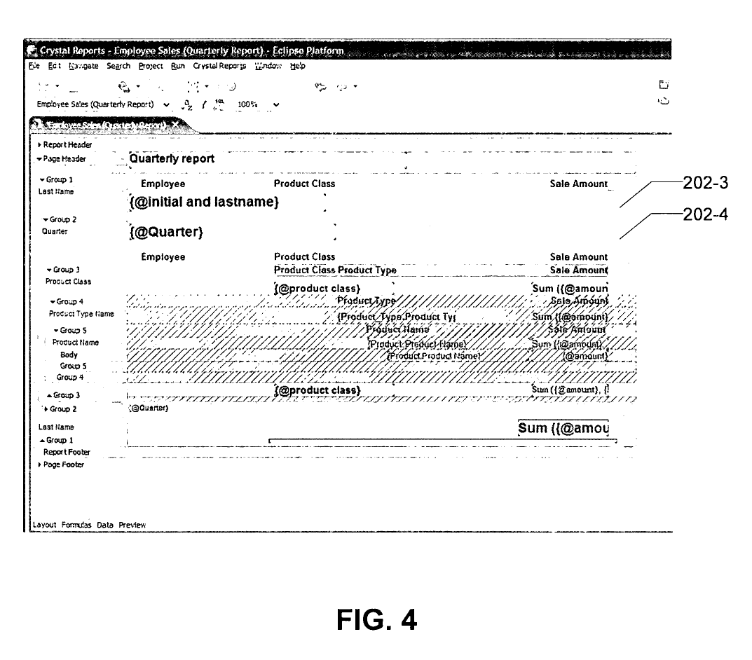

The invention supports drag and drop operations. For example, the content of report segment 202_3 may be dropped into report segment 202_4 and vice versa. FIG. 4 illustrates the result of this operation. Observe in FIG. 4 that the content “{@initial and lastname}” that appeared in segment 202_4 of FIG. 3 now appears in segment 202_3 of FIG. 4. Similarly, the content “{@Quarter}” that appeared in segment 202_3 of FIG. 3 now appears in segment 202_4 of FIG. 4.

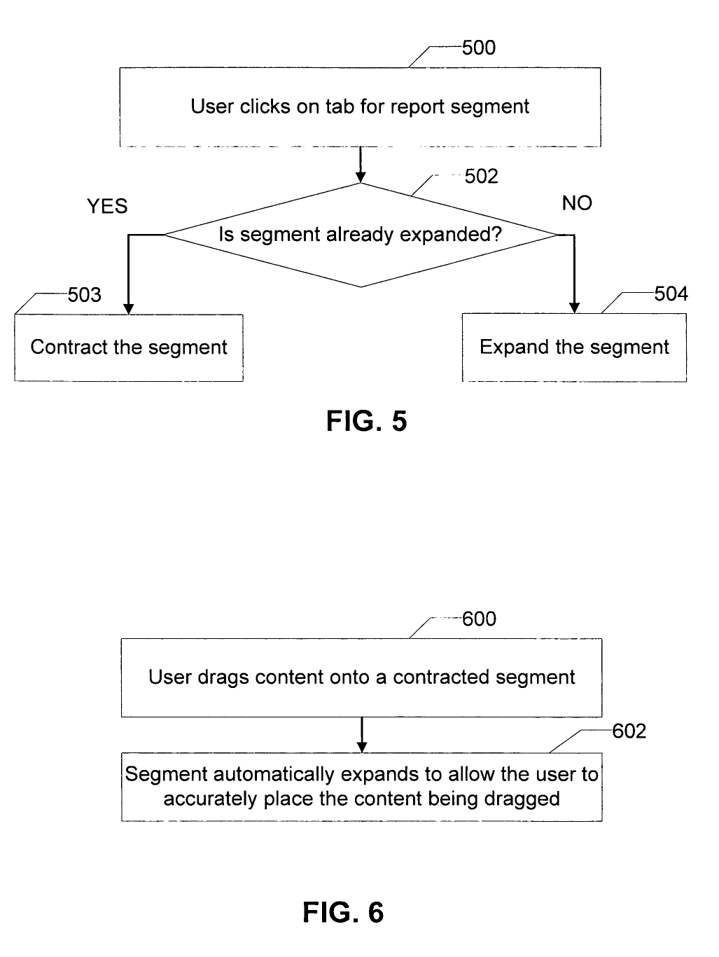

FIG. 5 illustrates processing operations associated with an embodiment of the invention. A user clicks on a tab (e.g., arrowhead 204) of a report segment 500. It is then determined whether the segment is expanded (decision block 502). If the segment is expanded, the segment is contracted 503. If the segment is contracted, the segment is then expanded 504.

FIG. 6 illustrates processing operations associated with another embodiment of the invention. A user drags content onto a contracted segment 600. The contracted segment is then automatically expanded to allow the user to accurately place the content being dragged 602. This also facilitates easier reading of the content.

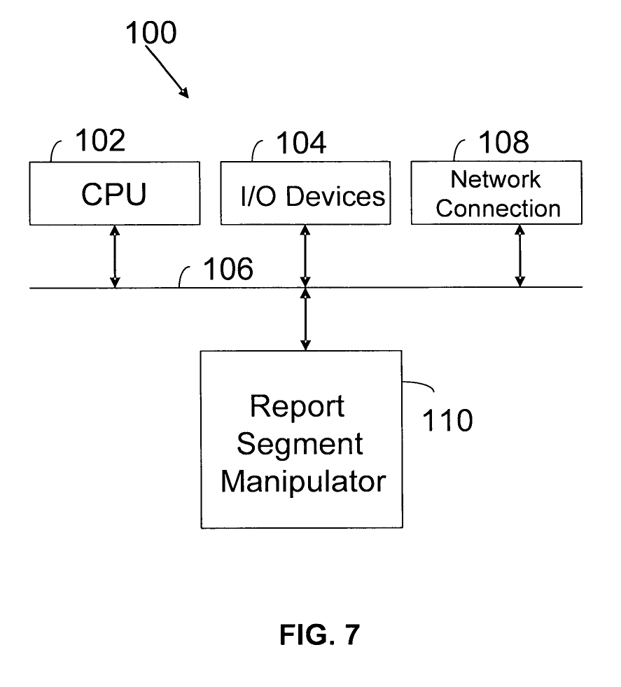

FIG. 7 illustrates a computer 100 configured in accordance with an embodiment of the invention. The computer 100 includes standard components, such as a central processing unit 102 and a set of input/output devices 104, which are connected by a bus 106. Also connected to the bus 106 is a network connection circuit 108 to provide connectivity to a network (not shown). A report segment manipulator 110 is stored in a memory connected to bus 106. The report segment manipulator 110 includes executable instructions to implement the sizing, dragging, dropping and other operations disclosed herein.

In one embodiment of the invention, each group segment has a group header, details section, and group footer. Preferably, these sections expand and collapse independently. Thus, in the case of a long group, one can focus on the details section without having to display the group header and footer.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium includes executable instructions to:
display a report as a set of report segments;
facilitate the expansion and collapse of individual report segments; and
coordinate drag and drop operations between individual report segments.

2. The computer readable medium of claim 1, wherein the executable instructions to coordinate drag and drop operations include executable instructions to expand a report segment when content is being dragged into the report segment.

3. The computer readable medium of claim 1 wherein the set of report segments includes at least one area segment and group segments.

4. The computer readable medium of claim 3 wherein group segments are a subset of an area segment.

5. The computer readable medium of claim 3 wherein each area segment corresponds to a fixed structure section of a report.

6. The computer readable medium of claim 3 wherein each group segment corresponds to data within a report.

7. The computer readable medium of claim 3 wherein the executable instructions to coordinate drag and drop operations between individual report segments include executable instructions to drag and drop group segments.

8. The computer readable medium of claim 1 wherein the executable instructions to facilitate the expansion and collapse of individual report segments include executable instructions responsive to the activation of a tab on a graphical user interface.

9. The computer readable medium of claim 8 wherein the executable instructions responsive to the activation of a tab include executable instructions to expand a report segment on a first activation of the tab.

10. The computer readable medium of claim 8 wherein the executable instructions responsive to the activation of a tab include executable instructions to collapse a report segment on a second activation of the tab.
